(19) United States
(12) Patent Application Publication
(10) Pub. No.: US 2007/0170318 A1
(43) Pub. Date: Jul. 26, 2007

(54) Ventilator breathing tube support arm

(75) Inventor: Thomas R. Gunerman, Cazenovia, NY (US)

Correspondence Address: BROWN & MICHAELS, PC;400 M & T BANK BUILDING, 118 NORTH TIOGA ST, ITHACA, NY, 14850, US

(73) Assignee: INTERSURGICAL, INC., Liverpool, NY (US)

(21) Appl. No.: 11/568,334

(22) PCT Filed: Apr. 27, 2004
(86) PCT No.: PCT/US04/12871

§ 371 Date: Oct. 26, 2006

(51) Int. Cl. F16L 3/22

(52) U.S. Cl. 248/68.1

(57) ABSTRACT

A breathing tube support arm for supporting a patient's breathing tube(s) includes a system of hollow, interlocking, articulating devices, and a system of stiffeners inside of said hollow, articulating devices, the system including stiffeners of three different stiffnesses. An embodiment includes a system of hollow, interlocking, articulating devices, a system of stiffeners inside the hollow articulating devices, the system including stiffeners of three different stiffnesses, a connector at a base end of the support arm for receiving a universal rail mount block, and a tube holder or connector for receiving a tube holder at a top end of the support arm.

### BACKGROUND OF THE INVENTION

1. Field of the Invention

The invention pertains to the field of medical devices. More particularly, the invention pertains to a ventilator breathing tube support arm for supporting and anchoring a patient's breathing tubes.

2. Description of the Related Art

A breathing tube is a plastic, rubber or silicone tube used during artificial respiration, a procedure to assist a patient in breathing. One end of the breathing (endotracheal) tube is placed into the windpipe (trachea) through the mouth or nose. The other end of the tube is connected to a breathing machine (mechanical ventilator) or breathing bag (manual resuscitator). The breathing tube provides an airway so that air and oxygen from the breathing machine or breathing bag can be provided to the lungs.

The breathing tube typically is held in place with tape or a plastic device. Usually, nurses and respiratory therapists secure the tube with tape. Typically the tape extends around the neck to form a circle of tape holding the tube in place. Normally, the patient cannot talk with the breathing tube in place, because the breathing tube passes through the vocal cords and prevents them from moving.

Complications associated with use of a breathing tube include the fact that breathing tubes can become displaced and may require reinsertion, or may become disconnected or obstructed. This most commonly happens if the patient is agitated and/or vigorously moving. Some patients attempt to remove the tubes themselves. This is one of the reasons that patient's hands typically are gently restrained and mild sedation is used.

A breathing circuit or breathing system is that part of an anaesthetic apparatus that typically includes a reservoir and rebreathing bags, corrugated flexible hoses, absorbers, facepiece, and some ventilator components. Pressure in the breathing circuit is always close to atmospheric pressure, except for the small pressure required for positive pressure ventilation. Generally, the function of any breathing circuit is to deliver oxygen and anesthetic gases, and eliminate carbon dioxide (the latter either by washout with adequate fresh gas flow (FGF) or by soda lime absorption).

There are two main types of breathing circuit: 1) rebreathing (closed circuits), in which part or all of the expired gases are intentionally re-inspired; and 2) non-rebreathing circuits, in which new gases are supplied for each breath, and any rebreathing which occurs is due to dead space in the breathing circuit.

Generally, a breathing tube support arm is a medical device for supporting and anchoring a patient's breathing tubes, which may include an endotracheal tube or a breathing tube in association with a breathing circuit.

Under 21 C.F.R. § 868.5280:
Breathing tube support.
   (a) Identification. A breathing tube support is a device that is intended to support and anchor a patient's breathing tube(s).
   (b) Classification. Class I (general controls). The device is exempt from the premarket notification procedures in subpart E of part 807 of this chapter subject to the limitations in Sec. 868.9.

### SUMMARY OF THE INVENTION

Briefly stated, a breathing tube support arm for supporting a patient's breathing tube(s) includes a system of hollow, interlocking, articulating devices, and a system of stiffeners inside of said hollow, articulating devices, the system including stiffeners of three different stiffnesses.

In one embodiment, a breathing tube support arm for supporting a patient's breathing tube(s) includes a system of hollow, interlocking, articulating devices, a system of stiffeners inside the hollow articulating devices, the system including stiffeners of three different stiffnesses, a connector at a base end of the support arm for receiving a universal rail mount block, and a tube holder or connector for receiving a tube holder at a top end of the support arm.

### BRIEF DESCRIPTION OF THE DRAWING

FIG. 1 shows an embodiment of the support arm of the present invention.

FIG. 2A shows a cut away view of a support arm of the invention, further depicting the snap-lock beads.

FIG. 2B shows an exploded view of a support arm of the invention, further depicting the snap-lock beads, multiple stiffeners and a cover.

FIG. 3A shows a view of the top end of an embodiment of the support arm of the present invention.

FIG. 3B shows a view of the bottom end of an embodiment of the support arm of the present invention.

FIG. 4 shows a cross section view of an embodiment of the support arm of the present invention.

FIG. 5 shows the support arm of the present invention engaged with a universal rail mount block.

FIGS. 6A-6C show three different size tube holders: 15 mm (FIG. 6A), 22 mm (FIG. 6C, and 15 mm & 22 mm combination (FIG. 6B).

### DETAILED DESCRIPTION OF THE INVENTION

The present invention provides a ventilator breathing tube support arm for supporting and anchoring a patient's breathing tube(s).

The support arm of the preferred embodiment can extend and suspend over, for example, an operating table, a hospital bed, a gurney, a residential bed, a specialized health care facility bed. The arm preferably attaches at the base end to various manufacturers' ventilators, and preferably supports at least two flexible breathing tubes and holder attached at the top end. The arm preferably supports a minimum weight of 8 ounces suspended from the top end. The arm is flexible and yet holds relative position once it is suspended over a patient. The arm preferably is able to be cleaned easily with alcohol wipes and/or sanitizing agents.

As a result of using the different stiffeners, the arm assembly extends from the connection at the mounting block on the ventilator and arcs over the patient. Once positioned, the arm assembly holds relative position. The two breathing tubes from the ventilator affix to the tube holder located at the (suspended) upper end of the arm. The 22 mm tube holder is used for adult patients. The 15 mm tube holder is used for child patients. From that position, the two breathing tubes connect to a Y-pipe which is connected to the tracheal tube which is inserted into the patient's esophagus. The arm is not locked in position.

The flexibility of the various stiffeners allows the arm to be easily positioned, yet once positioned, will maintain relative position and move with the patient. The arm flexes/moves as the patient moves, yet will not collapse onto the patient.

### EXAMPLE 1

Using a system of interconnecting “snap-lock” beads 20 (Cedarberg Industries, Eagan, Minn.), an articulated support arm similar to a vertebral column was assembled, the preferred embodiment having one (1) female connector, twenty (20) bead segments, nine (9) extender segments, and one (1) male connector. The overall length of this assembly is 40¾″. The total working length of the finished arm is 42″.

Preferably there is a connector at the base end of the arm that screws into an existing universal rail mount block (available off the shelf).

As part of the arm assembly, a tube holder preferably is fastened at the top of the arm. There are three different size tube holders: 15 mm, 22 mm, and 15 mm & 22 mm combination. The arm supports a weight up to twelve (12) ounces suspended at the top end. Three different flex capability stiffeners allow the arm to maneuver easily. The arm holds relative position due to the three different flex stiffeners. The arm preferably includes a PVC sleeve covering the outside, that can be cleaned with alcohol wipes and/or sanitizing agents. The sleeve can be removed and replaced easily.

There are three stiffeners incorporated in the arm design, each of which has a different flex capability. Stiffener A is a 22.5″ length of THEN 1/0 stranded copper cable with an extruded neoprene jacket. This cable is a standard wire and cable industry product readily available off the shelf. The outer diameter of the cable slides snugly into the snap-lock extender segments and the male connector. The copper stiffener is a firm-flex and keeps the lower segment of the arm more rigid. It allows the arm to flex slightly. It keeps the arm from bending over with the weight of the upper arm assembly and the ventilator breathing tube assembly that is supported at the top end.

Stiffener B is a 12.5″ length of XHHN 1/0 stranded aluminum cable with an extruded neoprene jacket. This cable is a standard wire and cable industry product readily available off the shelf. The outer diameter of the cable slides snugly into the snap-lock bead segments. The aluminum stiffener is a mid flex and allows the middle segment of the arm to be more flexible than the lower segment.

Stiffener C is a 76.5″ length of rubber or plastic (or similar material) tubing (e.g., Tygon™ brand). This tube is a standard plumbing industry product readily available off the shelf. The outer diameter with 1/16″ wall thickness slides snugly into the snap-lock bead segments and the female connector. The tubing stiffener is a soft-flex and allows the upper segment of the arm to be greatly flexed for pinpoint positioning near the patient's mouth.

Using the preferred combination of beads and extenders, and I/0 cables as internal stiffeners, the arm is capable of being a free suspension length long enough to reach over the patient without any additional support. The 42″ total suspended length will support up to 12 ounces of weight.

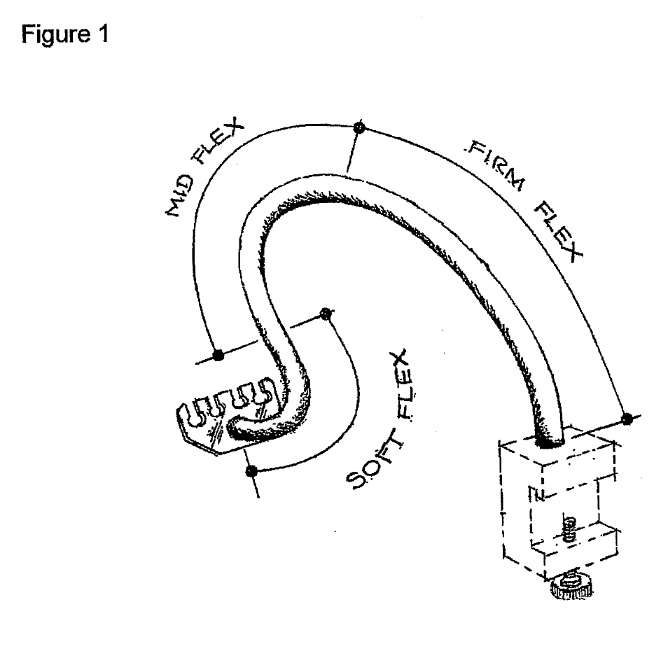

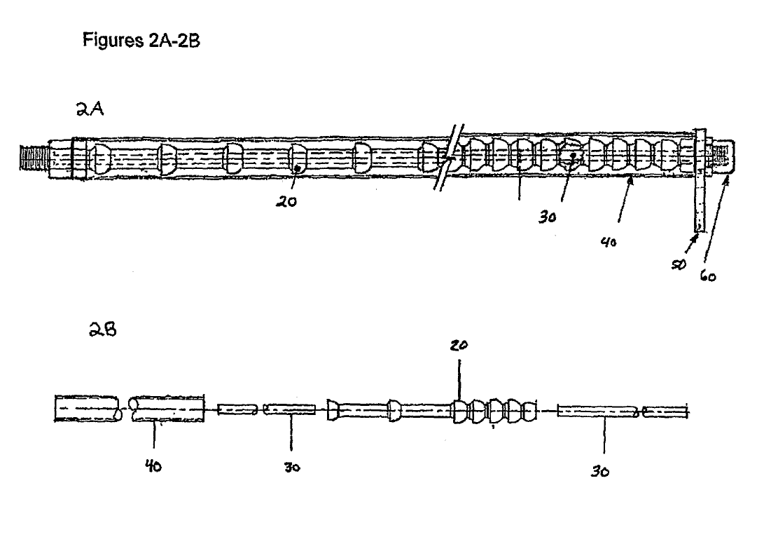

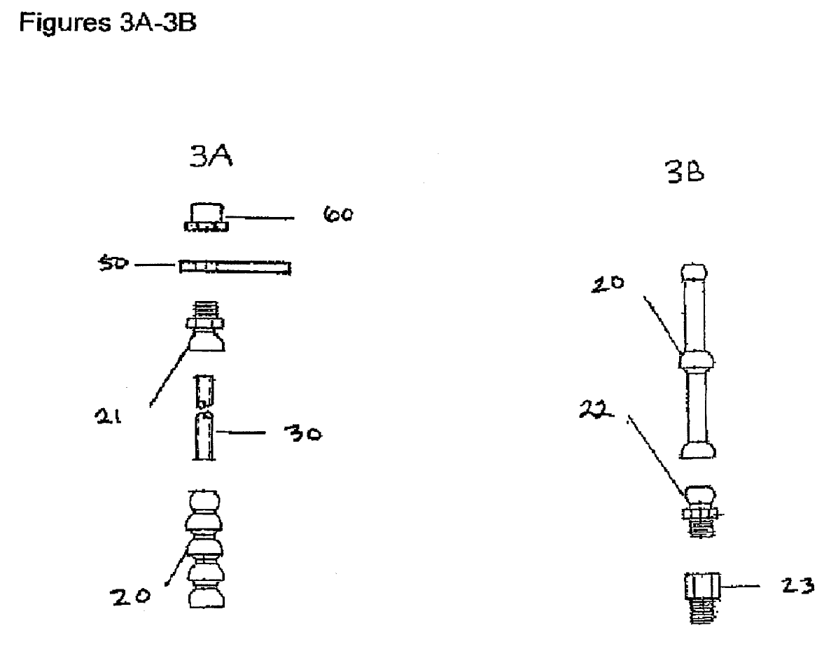

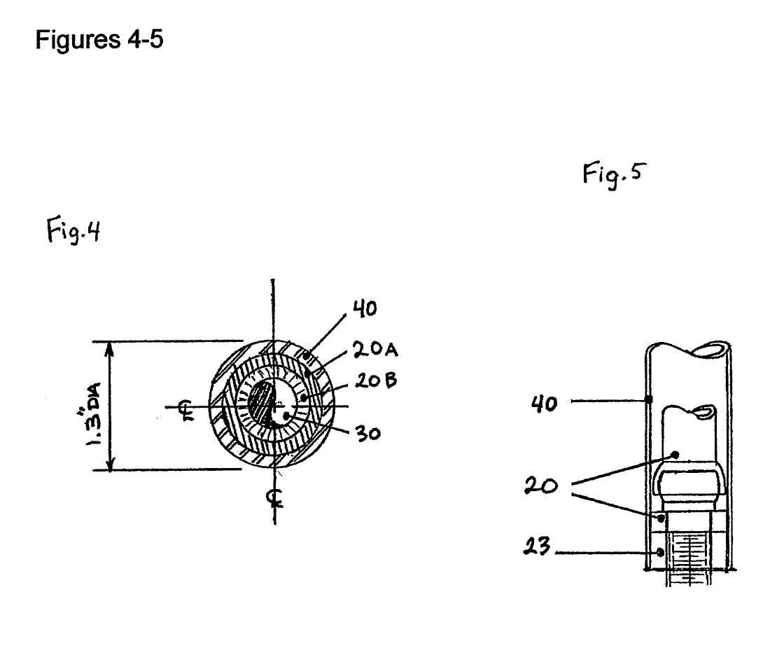

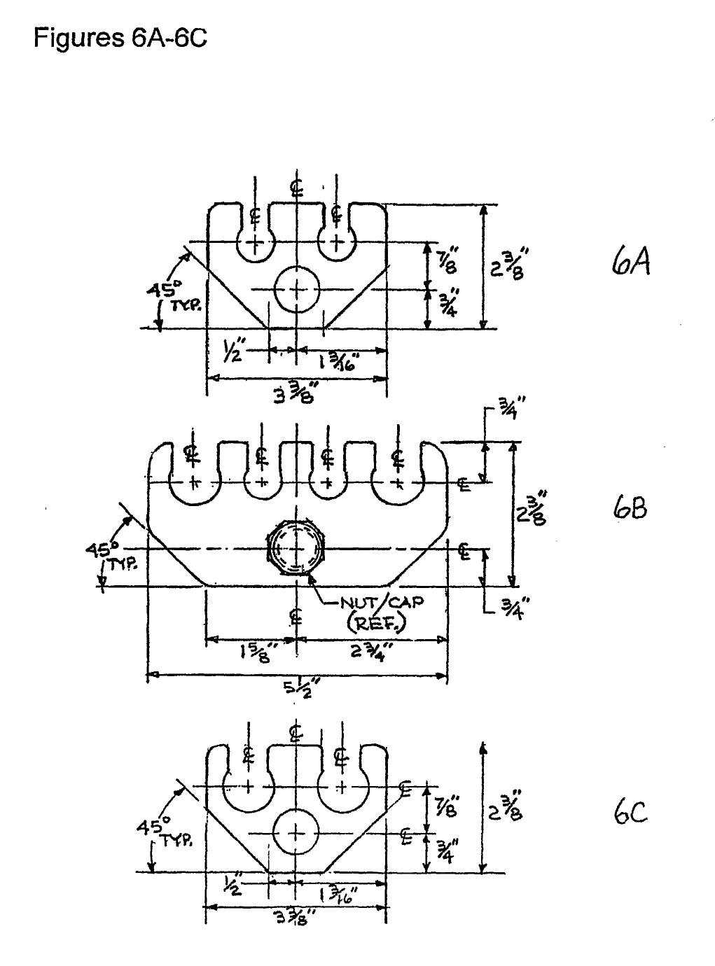

Referring now to FIGS. 1-3 generally, a preferred embodiment of the invention is shown. The breathing tube support arm includes a system of hollow, interlocking, articulating beads 20, and a system of stiffeners 30 inside of said hollow articulating beads, wherein the stiffeners are of three different stiffnesses. Preferably the breathing tube support arm farther includes a connector 23 at a base end of the support arm for receiving a universal rail mount block, and a tube holder 50 and/or connector 21 for receiving a tube holder 50 at a top end of the support arm. Optionally, the support arm further includes a durable, sanitary cover 40.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A breathing tube support arm comprising:
a system of hollow, interlocking, articulating means; and
a system of stiffeners inside of said hollow articulating means, said system comprising stiffeners of three different stiffnesses.

2. The breathing tube support arm of claim 1, further comprising a connector at a base end of said support arm for receiving a universal rail mount block.

3. The breathing tube support arm of claim 1, further comprising a tube holder or connector for receiving a tube holder at a top end of said support arm.

4. The breathing tube support arm of claim 3, wherein said tube holder is a size selected from the group consisting of 15 mm, 22 mm, and 15 mm/22 mm combination.

5. The breathing tube support arm of claim 1, wherein said support arm supports a weight of up to 8 ounces suspended from a top end thereof.

6. The breathing tube support arm of claim 5, wherein said support arm is at least 42 inches in total length.

7. The breathing tube support arm of claim 1, wherein said support arm supports a weight of up to 12 ounces suspended from a top end thereof.

8. The breathing tube support arm of claim 7, wherein said support arm is at least 42 inches in total length.

9. The breathing tube support arm of claim 1, wherein at least one of said stiffeners comprises stranded copper cable with an extruded neoprene jacket.

10. The breathing tube support arm of claim 1, wherein at least one of said stiffeners comprises stranded aluminum cable with an extruded neoprene jacket.

11. The breathing tube support arm of claim 1, wherein at least one of said stiffeners comprises plastic or rubber tubing.

12. The breathing tube support arm of claim 1, further comprising a durable, sanitary cover.

13. The breathing tube support arm of claim 12, wherein said cover comprises a PVC material.

14. A breathing tube support arm comprising:
a system of hollow, interlocking, articulating means;
a system of stiffeners inside said hollow articulating means, said system comprising stiffeners of three different stiffnesses;
a connector at a base end of said support arm for receiving a universal rail mount block; and
a tube holder or connector for receiving a tube holder at a top end of said support arm.

15. The breathing tube support arm of claim 14, wherein said tube holder is a size selected from the group consisting of 15 mm, 22 mm, and 15 mm/22 mm combination.

16. The breathing tube support arm of claim 14, wherein said support arm supports a weight of up to 12 ounces suspended from a top end thereof.

17. The breathing tube support arm of claim 16, wherein said support arm is at least 42 inches in total length.

18. The breathing tube support arm of claim 14, wherein at least one of said stiffeners comprises stranded copper cable with an extruded neoprene jacket.

19. The breathing tube support arm of claim 14, wherein at least one of said stiffeners comprises stranded aluminum cable with an extruded neoprene jacket.

20. The breathing tube support arm of claim 14, wherein at least one of said stiffeners comprises plastic or rubber tubing.

21. The breathing tube support arm of claim 1, further comprising a durable, sanitary cover.

22. The breathing tube support arm of claim 12, wherein said cover comprises a PVC material.
